(19) United States
(12) Patent Application Publication
(10) Pub. No.: US 2018/0111214 A1
(43) Pub. Date: Apr. 26, 2018

(54) FLEXIBLE ASSEMBLY LINE AND METHOD

(71) Applicant: METALSA S.A. DE C.V., Apodaca (MX)

(72) Inventors: Juan Villarreal Garcia, Saltillo (MX); Alvaro Martínez Soto, Apodaca (MX)

(21) Appl. No.: 15/791,565

(22) Filed: Oct. 24, 2017

Related U.S. Application Data
(60) Provisional application No. 62/413,066, filed on Oct. 26, 2016.

(51) Int. Cl. B23K 9/025; B23P 21/00; B62D 65/02; B62D 27/02

(52) U.S. Cl. CPC B23K 9/025; B23P 21/004; B23K 2201/006; B62D 27/023; B62D 65/022

(57) ABSTRACT

A flexible assembly line includes a common welding station having a first set of tooling adapted to engage and support a first type of vehicle frame and a second set of tooling adapted to engage and support a second type of vehicle frame. The first set of tooling is provided on a first side of a rotatable unit and the second set of tooling is provided on a second side of the rotatable unit such that the rotatable unit is rotatable to present either the first set of tooling or the second set of tooling for a welding operation. The flexible assembly includes a first dedicated welding station having dedicated tooling particularly adapted to engage and support only the first type of vehicle frame. The flexible assembly includes a second dedicated welding station having dedicated tooling particularly adapted to engage and support only the second type of vehicle frame.

### REFERENCE TO RELATED APPLICATIONS

This application claims priority to U.S. Provisional Patent No. 62/413,066, filed Oct. 26, 2016, the entire contents of which are incorporated herein by reference.

### FIELD OF INVENTION

The present invention relates to assembly lines and assembly stations, in particular for automotive manufacture and assembly.

### BACKGROUND

The automotive industry is moving toward highly automated and highly efficient assembly processes. As auto manufacturers consolidate global platforms, manufacturing requirements within the industry are also being consolidated globally. The standardization of a global platform is usually related to the component design, but the volume demand and product specifications for each region still needs to be customized.

### SUMMARY

In one aspect, a flexible assembly line includes a common welding station having a first set of tooling adapted to engage and support a first type of vehicle frame and a second set of tooling adapted to engage and support a second type of vehicle frame, a base geometry of which is not common with the first type. The first set of tooling is provided on a first side of a rotatable unit and the second set of tooling is provided on a second side of the rotatable unit such that the rotatable unit is rotatable about a pivot axis to present either the first set of tooling or the second set of tooling for a welding operation. The flexible assembly also includes a first dedicated welding station having dedicated tooling particularly adapted to engage and support only the first type of vehicle frame. The flexible assembly further includes a second dedicated welding station having dedicated tooling particularly adapted to engage and support only the second type of vehicle frame.

In another aspect, a flexible assembly line includes a common welding station having a fixed base and a table rotatably coupled to the fixed base about a rotational axis. The table includes a first side and an opposing second side. The common welding station includes a first set of tooling coupled to the first side of the table. The first set of tooling is configured to engage and support a first vehicle frame. The common welding station also includes a second set of tooling coupled to the second side of the table. The second set of tooling is configured to engage and support a second vehicle frame. The second vehicle frame is geometrically different than the first vehicle frame. The table is moveable about the rotational axis to present either the first side of the table or the second side of the table for a welding operation.

In yet another aspect, a method of constructing vehicle frames on a flexible assembly line includes joining separate elements of a first vehicle frame of a first type by welding at a first dedicated welding station, joining separate elements of a second vehicle frame of a second type, a base geometry of which is not common to the first type, by welding at a second dedicated welding station, providing a common welding station. The common welding station includes a first configuration in which a first set of tooling is adapted for engaging and supporting the first vehicle frame and a second configuration in which a second set of tooling is adapted for engaging and supporting the second vehicle frame. The method also includes transferring the joined elements of the first vehicle frame to the common welding station such that the first vehicle frame is engaged and supported by the first set of tooling, further bonding the joined elements of the first vehicle frame by welding at the common welding station, rotating the common welding station into the second configuration, transferring the joined elements of the second vehicle frame to the common welding station such that the second vehicle frame is engaged and supported by the second set of tooling, and further bonding the joined elements of the second vehicle frame by welding at the common welding station.

### BRIEF DESCRIPTION OF THE DRAWINGS

FIG. 1 is a plan view of a portion of a vehicle frame assembly line according to one embodiment of the invention.

FIG. 2 is a side view of a portion of one common welding station of the assembly line of FIG. 1, including a rotating table with two separate sets of tooling.

FIG. 3 is a perspective view of the portion of the common welding station of FIG. 2.

FIG. 4 is a perspective view of the common welding station of FIGS. 2 and 3 in which all the elements of one tooling set are integrated together on a removable plate.

FIG. 5 is a detail perspective view of the common welding station of FIGS. 2 and 3, engaging and supporting a vehicle frame.

FIG. 6 illustrates a releasable holding mechanism of the common welding station in an open position.

FIG. 7 illustrates a releasable holding mechanism of the common welding station in a closed position to secure the vehicle frame to the common welding station.

FIG. 8 is a perspective view of a welding table of the common welding station.

FIG. 9 is an exploded assembly view illustrating a pin connection between the welding table of FIG. 8 and a tooling element.

FIG. 10 is a perspective view illustrating two dedicated welding stations movably supported on a tooling-tray.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

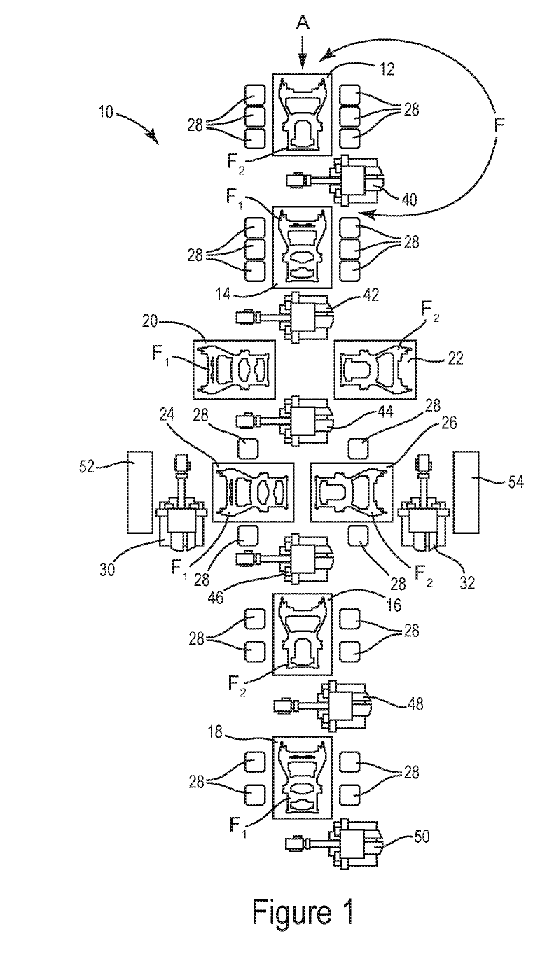

FIG. 1 illustrates an assembly line 10 for performing assembly of metal products, for example welding of first vehicle frames F₁ and second vehicle frames F₂ (collectively referred to as vehicle frames F). The illustrated first vehicle frames F₁ include a base geometry of which is not common with a base geometry of the second vehicle frames F₂ (i.e., the first vehicle frames F₁ are different and distinct from the second vehicle frames F₂). As discussed in further detail below, the assembly line 10 comprises a plurality of common welding stations 12, 14, 16, 18 and a plurality of dedicated welding stations, 20, 22, 24, 26. Each of the common welding stations 12, 14, 16, 18 is adapted to manufacture at least two different types of products while each of the dedicated welding stations 20, 22, 24, 26 is specifically adapted for manufacturing only a single type of product. For example, each of the common welding stations 12, 14, 16, 18 is adapted to accommodate the manufacture of frames of at least two entirely different vehicle platforms (e.g., the first and second vehicle frames F₁, F₂) while each of the dedicated welding stations 20, 22, 24, 26 is specifically adapted for manufacturing frames of only a single vehicle platform (e.g., the first vehicle frames F₁ or the second vehicle frames F₂).

A vehicle platform belongs to a given vehicle manufacturer and forms the basis upon which a variety of different types of vehicles can be manufactured. Although the different types of vehicles on the common platform can have a wide variety of unique subcomponents and features (e.g., different wheelbase, different suspension type, different number or configuration of doors or roofs, etc.) the platform represents a certain amount of commonality, defining a base geometry, among all the vehicle types. For a given vehicle platform, the size and shape of the vehicle frame may be wholly identical or have wholly identical portions, defining the base geometry, among different vehicle types on the platform, and it may represent an advantage to the automaker to maximize the amount of commonality. However, frames for vehicles of separate platforms, whether separate platforms of a single automaker or certainly those of separate automakers, are not designed with standardization of size or shape and are instead of independent design, not sharing any base geometry.

As shown in FIG. 1, the layout of the assembly line 10 (which can include additional stations upstream and/or downstream of the illustrated portion) defines an assembly direction as indicated by an arrow A, along which work pieces (e.g., the vehicle frames F) move during assembly. The illustrated portion of the assembly line 10 includes, from upstream to downstream: the first common welding station 12, the second common welding station 14, two dedicated welding stations 20, 22, two additional dedicated welding stations 24, 26, the third common welding station 16, and the fourth common welding station 18. A plurality of transfer devices 40, 42, 44, 46, 48, 50 along the assembly line 10 are provided to move the products from station to station. The first transfer device 40 is arranged between the first and second common welding stations 12, 14 and is operable to transfer products from the first common welding station 12 to the second common welding station 14. The second transfer device 42 is arranged between the second common welding station 14 and the two dedicated welding stations 20, 22 and is operable to transfer products from the second common welding station 14 to either one of the dedicated welding stations 20, 22 as necessary. The third transfer device 44 is arranged between the two dedicated welding stations 20, 22 and the two additional dedicated welding stations 24, 26 and is operable to transfer products either from the dedicated welding station 20 (left) to the additional dedicated welding station 24 (left) or from the dedicated welding station 22 (right) to the other additional dedicated welding station 26 (right). The fourth transfer device 46 is arranged between the two additional dedicated welding stations 24, 26 and the third common welding station 16 and is operable to transfer products from the dedicated welding station 24 to the third common welding station 16, and further operable to transfer products from the dedicated welding station 26 to the third common welding station 16. The fifth transfer device 48 is arranged between the third and fourth common welding stations 16, 18 and is operable to transfer products from the third common welding station 16 to the fourth common welding station 18. The sixth transfer device 50 is arranged downstream of the fourth common welding station 18 to remove products from the fourth common welding station 18. Each of the transfer devices 40, 42, 44, 46, 48, 50 can be a material handling robot, but other alternative elements include lift and carry systems, overhead transfer, or roller beds for manual transfer, among others.

As shown by common symbols throughout FIG. 1, a plurality of welding robots 28 are provided at the common and dedicated welding stations 12, 14, 16, 18, 20, 22, 24, 26. For example, each of the first and second common welding stations 12, 14 includes six welding robots 28 in a three-per-side arrangement. Each dedicated welding station 24, 26 includes two welding robots 28 in a one-per-side arrangement. The third and fourth common welding stations 16, 18 each include four welding robots 28 in a two-per-side arrangement. Other numbers and arrangements of the welding robots 28 besides those shown in FIG. 1 are also contemplated. It is also noted that some stations, as shown with the illustrated dedicated welding stations 20, 22, may not include any welding robots 28. Rather, welding may be performed exclusively by a human welder. This is true of any of the stations 12, 14, 16, 18, 20, 22, 24, 26 of the assembly line 10, and it is further noted that welding at any given station 12, 14, 16, 18, 20, 22, 24, 26 may be performed by a combination of human and robot welders.

One or more of the dedicated welding stations 20, 22, 24, 26 may include removable tooling. In order to provide additional flexibility to the assembly line 10, one or more of the dedicated welding stations 20, 22, 24, 26 can be repurposed with alternate tooling available from an in-line warehouse 52, 54 (FIG. 1). For example, handling and transfer robots 30, 32 as shown adjacent each of the dedicated welding stations 24, 26 may be operable to automatically change the tooling at any or all of the dedicated welding stations 20, 22, 24, 26. The tooling used at such welding stations include structural elements such as grips, clamps, jaws, fixtures that are adapted to engage and support the work piece, such as the vehicle frames F. Thus, repurposing the dedicated welding stations 20, 22, 24, 26 enables these stations to change the type of vehicle frame that they are adapted to engage and support. In one particular aspect, this allows the dedicated welding stations 20, 22, 24, 26 to change to accommodate frames conforming to wholly different vehicle platforms. In some constructions, one upstream-downstream pair of the dedicated welding stations (e.g., dedicated welding stations 22, 26) can be repurposed for an alternate platform while the assembly line 10 is processing frames F on another parallel upstream-downstream pair of dedicated welding stations (e.g., dedicated welding stations 20, 24).

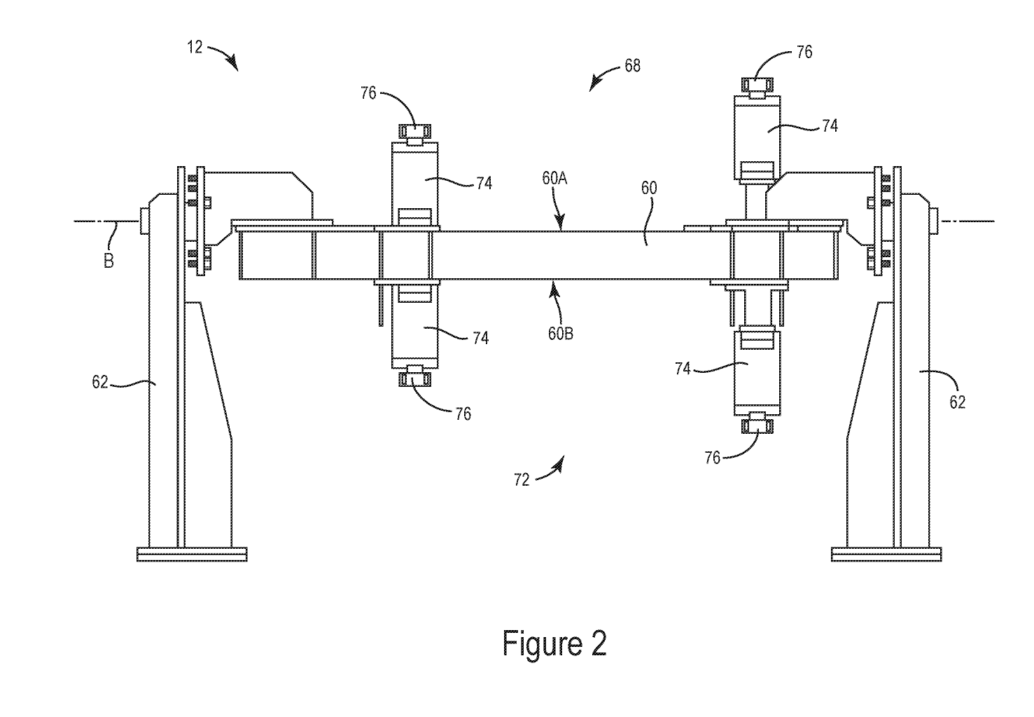

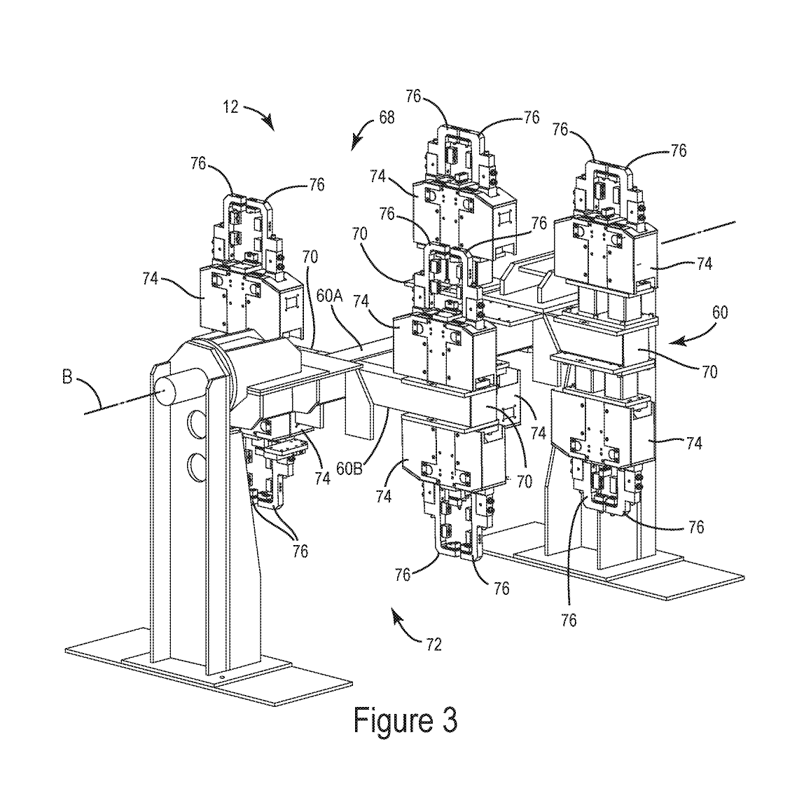

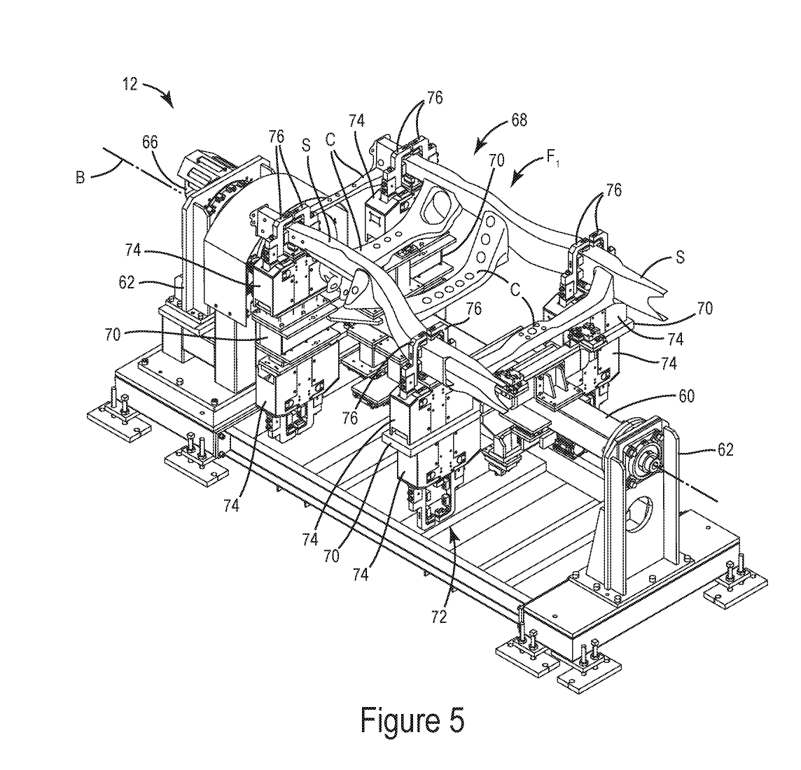

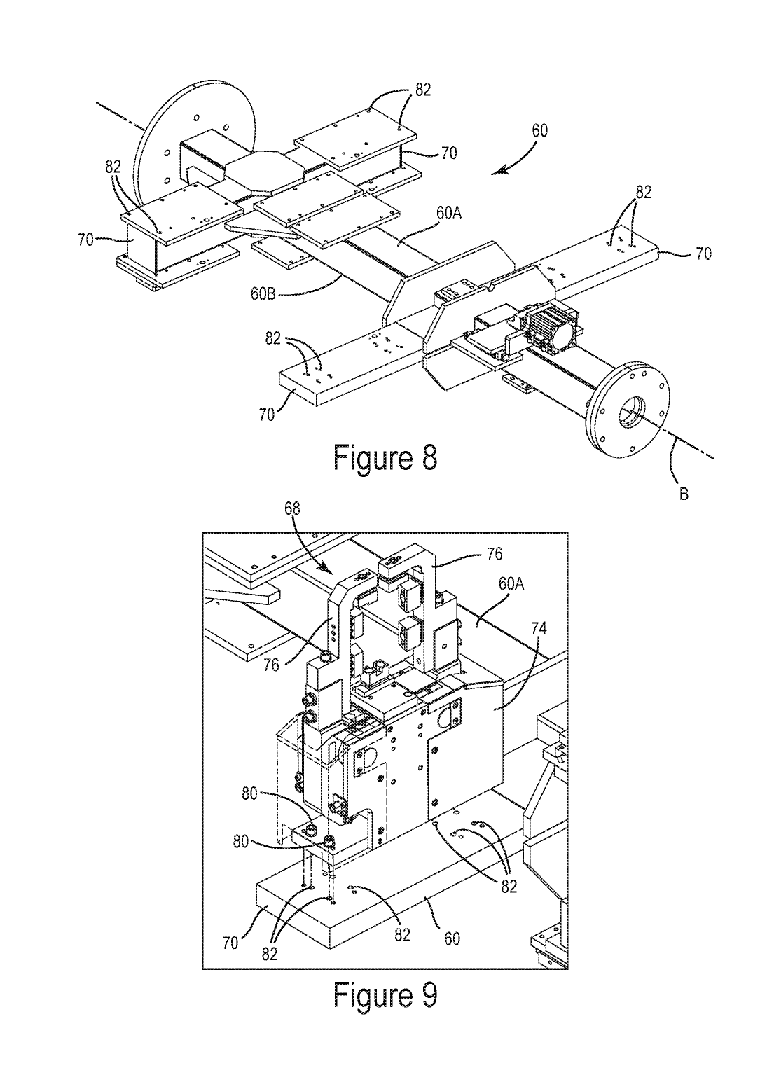

Referring to FIGS. 2 to 9, the common welding station 12 is shown in further detail with the understanding that all its features may also apply to the other common welding stations 14, 16, 18 of FIG. 1. The common welding station 12 includes a welding table 60 supported by one or more fixed bases 62 in a rotatable manner such that the welding table 60 is rotatable about a rotational axis B. In some constructions, the welding table 60 has a full 360-degree range of motion about the rotational axis B in one or both directions (i.e., ±360 degrees). The common welding station 12 further comprises one or more servomotors 66 (FIG. 5) operable by electronic control to rotate the welding table 60 to any desired rotational orientation. With reference to FIGS. 2 and 3, the welding table 60 has two opposing sides 60A, 60B, each of which accommodates a different tooling set 68, 72. In particular, the welding table 60 includes arms 70 (e.g., four arms 70; FIGS. 3 and 8) each extending away from the rotational axis B with the first tooling set 68 coupled to the first side 60A of the arms 70 and the second tooling set 72 coupled to the second side 60B of the arms 70. Together with the welding table 60, the tooling sets 68, 72 provide a rotatable unit, rotatably supported by the fixed bases 62. The tooling sets 68, 72 are unique from each other such that each is adapted to engage and secure a different type of product, for example, a different type of vehicle frame F of a different platform. In the illustrated construction, each tooling set 68, 72 includes a plurality of individual tooling base elements 74 each coupled to one side 60A, 60B of a corresponding arm 70 and arranged in a spaced-apart rectangular array across the corresponding side of the welding table 60 (FIG. 3). The exact size, shape, layout, and structure of the base elements 74 of the tooling sets 68, 72 may be specifically adapted to interface with the product that will be assembled. In some constructions, each of the tooling sets 68, 72 holds the corresponding product in a way that it is restricted in every axis to reduce the potential variation that the final product would have if it were secured in 2 axes or 1 axis. Each tooling set 68, 72 also includes a releasable holding mechanism 76 (e.g., grips, clamps, jaws, fixtures, or the like) coupled to a corresponding base element 74 for engaging and securing the product to the welding table 60.

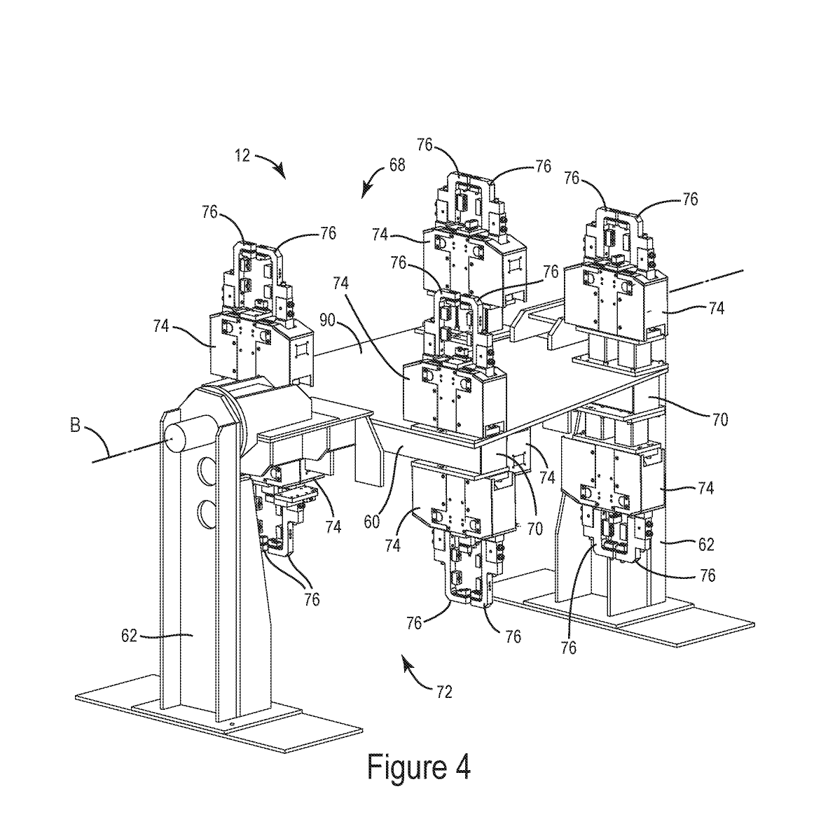

As shown specifically in FIG. 4, the common welding station 12 can include a receiving element 90 for receiving multiple or all of the base elements 74 of one of the tooling sets 68. For example, the receiving element 90 can be a plate having all the base elements 74 and the releasable holding mechanisms 76 of the tooling set 68 located on the first side 60A of the welding table 60. In addition to being able to rotate the welding table 60, this allows for a more convenient and efficient setup and removal of the tooling set 68 with the welding table 60. Although not shown, one or more of the base elements 74 and the corresponding releasable holding mechanisms 76 of the tooling set 72 on the opposite side 60B may also be secured to a common receiving element like the receiving element 90 shown in FIG. 4, though separate therefrom.

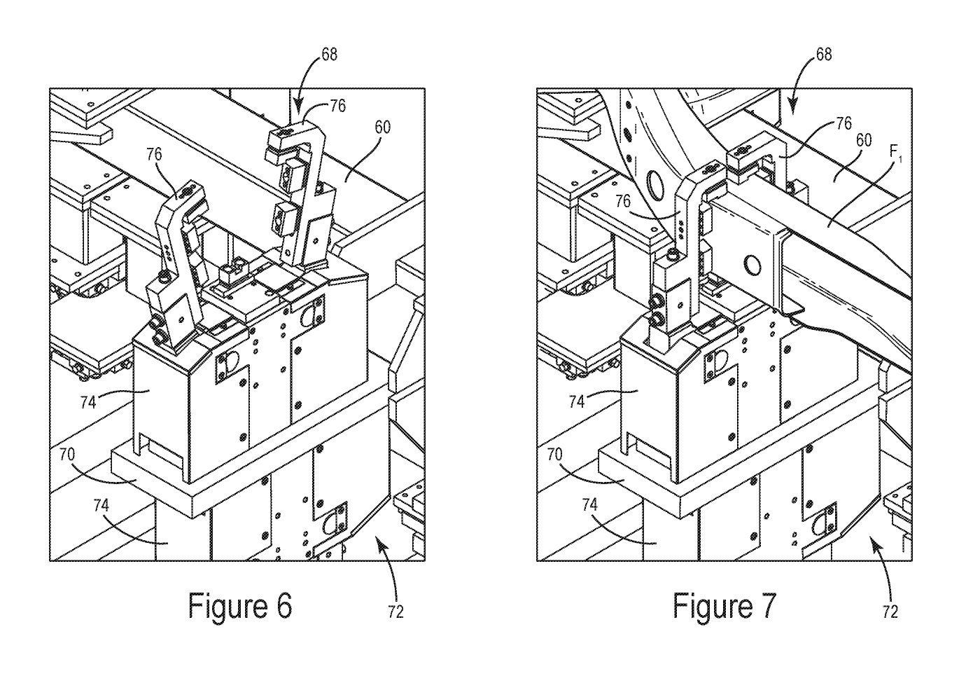

A more detailed construction of the common welding station 12 is shown in FIGS. 5 to 7, which also illustrate an exemplary first vehicle frame F₁, including side rails S and cross-members C, one or more of which may constitute a sub-frame of the overall first vehicle frame F₁. FIG. 6 illustrates an open or unlocked position of one of the releasable holding mechanisms 76 of the first tooling set 68 in order to receive a portion of the first vehicle frame F₁. As shown in this construction, each of the releasable holding mechanisms 76 includes a pair of opposed jaws, pivotable toward and away from one another, but the first tooling set 68 and/or the second tooling set 72 may take other forms in other constructions. As shown in FIGS. 5 and 7, the releasable holding mechanism 76 of the first tooling set 68 is in a closed or locked position to fix the first vehicle frame F₁ with respect to the welding table 60. Though fixed to the welding table 60, it is noted that the welding table 60 may be rotated about the rotational axis B (e.g., ±45 degrees from the home or neutral position of FIG. 5) by the servo motor 66 during the welding operation at the common welding station 12. This may facilitate enhanced access to certain areas of the first vehicle frame F₁ that are to be welded. The releasable holding mechanisms 76 of the second tooling set 72 operate similar to the releasable holding mechanisms 76 of the first tooling set 68. Also, the second vehicle frame F₂ is received and secured to the second tooling set 72 similarly to how the first vehicle frame F₁ is received and secured to the first tooling set 68. In one embodiment, only one of the first vehicle frame F₁ and the second vehicle frame F₂ is secured to the welding table 60 in an instance in time. In other embodiments, both the first vehicle frame F₁ and the second vehicle frame F₂ can be secured to the welding table 60 in an instance in time.

As shown in FIG. 9, each base element 74 of each of the tooling sets 68, 72 can be secured to one arm 70 of the welding table 60 with a quick tool-changer system, which in some constructions, comprises pins 80 located through the base elements 74 and sets of apertures 82 provided in the arms 70 to guarantee that the tooling sets 68, 72 will be placed exactly in their desired position without any position variance that could potentially cause product defects. The welding table 60 can also include multiple different sets of apertures 82 corresponding to different tooling sets. Although the pins 80 are shown on the base elements 74 and the apertures 82 are shown on the welding table 60, the arrangement may also be reversed in some constructions. The detachable welding table 60 is adapted to be connected to an air (or pneumatic) system and/or an electronic system through the base 62 for operating the releasable holding mechanisms 76 (i.e., opening and closing the releasable holding mechanisms 76) when attached through the pins 80 to the welding table 60.

In contrast to a quick tool-changer system as shown in FIGS. 8 and 9 and the detachable receiving element 90 of FIG. 4, the tooling sets 68, 72 can be fixedly secured together in other constructions. The tooling sets 68, 72 can form a single integrated unit that is attachable to and rotatably supported by the fixed bases 62. In such constructions, there is no separate welding table 60, per se. A structure similar to the illustrated welding table 60 may be provided as an integrated part of the tooling sets 68, 72 (e.g., being permanently secured together therebetween), or alternatively, the tooling sets 68, 72 themselves are modified from the illustrated construction to directly connect to each other without any intermediate structure (e.g., frame or table) therebetween. Even if the tooling sets 68, 72 are provided as an integrated unit without a separate welding table, the tooling sets 68, 72 are still provided on opposite sides of a rotatable unit, extending mutually apart from one another, to allow reconfiguration of the common welding station by rotation relative to the fixed bases 62 as described above.

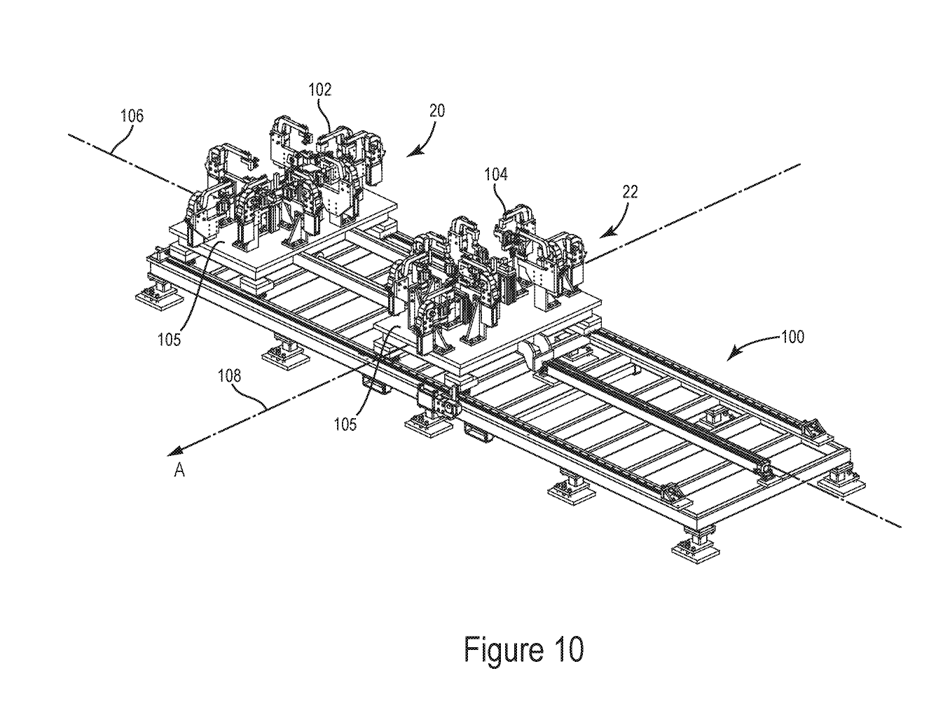

For the dedicated welding stations 20, 22, 24, 26, where the geometrical accuracy needs may be higher than those of the common welding stations 12, 14, 16, 18, the tooling may include a plurality of tooling elements similar to those of the common welding station 12, though more robust, larger, and/or of higher precision. For example, FIG. 10 shows two of the dedicated welding stations 20, 22, having respective tooling sets 102, 104, each of which is secured to a fixed, non-rotatable welding table 105. Flexibility of the assembly line 10 at the dedicated welding stations 20, 22 may be provided by the use of tooling-trays 100, as shown on FIG. 10, instead of rotatable welding stations. The track or tooling-tray 100 can movably (e.g., slidably) support multiple dedicated welding stations 20, 22. This allows positioning one of the dedicated welding stations 20, 22 at a given point along the assembly direction A, and then moving it away from the axis A so that the other one of the dedicated welding stations 20, 22 is moved to that common point along the assembly direction A. Each dedicated welding station 20, 22 has a different tooling set 102, 104 for the engagement and securement of different products, and the two dedicated welding stations 20, 22 are enabled to move along an axis 106 substantially perpendicular or transversely to the assembly direction A, allowing the positioning of the desired dedicated welding station 20, 22 in the assembly line 10 (e.g., along a central path or axis 108 of the assembly line 10), and at the same time, enabling the changing of the product tooling in a substantially lower time with high accuracy. The dedicated welding stations 20, 22 may be limited to the single-axis movement provided by the axis 106 the tooling-tray 100. In other words, the dedicated welding stations 20, 22 can be prohibited from moving vertically or parallel to the assembly line axis 108 and can be prohibited from any rotation.

The assembly line 10 has usually two different types of welding operations. A first or primary welding operation is an attaching operation, performed in the dedicated stations 20, 22, 24, 26, where separate components (e.g., a side rail S and a cross-member C) are joined together by, for example tack welding. A secondary or supplemental welding operation, performed at the common stations 12, 14, 16, 18, is a joint-strengthening operation wherein already joined elements are more completely welded together (i.e., partially or fully seam welded) to guarantee that a seam between the elements is not only positioned, but may be fully welded together. These primary and secondary welding operations may be repeated numerous times along the assembly line 10 for each new sub-component or sub-frame that is added to build the complete frame F. For example, the primary welding operation of the first vehicle frame F₁ can be performed at one of the dedicated stations 24, 26 (FIG. 1), and after completing the primary welding operation, the transfer device 46 can move the first vehicle frame F₁ to the common station 16 where the supplemental welding operation is performed. At the same or different time, the primary welding operation of the second vehicle frame F₂ can be performed at the other one of the dedicated stations 24, 26. However, before the second vehicle frame F₂ is moved to the common station 16 for the supplemental welding operation to occur, the first vehicle frame F₁ is moved to the common station 18 by the transfer device 48. As such, the common station 16 only supports one vehicle frame F at a time, and the common station 16 alternates between holding the first vehicle frame F₁ and the second vehicle frame F₂. In other embodiments, the assembly line 10 can include a grouping of one type of vehicle frame (e.g., the first vehicle frame F₁) so that multiple first vehicle frames F₁ are transferred from at least one of the dedicated stations 20, 22, 24, 26 to the common station 16 without alternating with the second vehicle frames F₂.

The flexible assembly stations of the assembly line 10 as described above can advantageously allow structural automotive components such as frames and sub-frames, from different product platforms, to be able to be manufactured within the same main assembly line 10. The assembly line 10 as described above can also provide a flexible system that is able to accommodate production volume variations by being able to be adapted for its use for another product as demand fluctuates. Furthermore, the assembly line 10 can be flexible and sufficiently robust to be re-used for more than one product platform.

Although the invention has been described in detail with reference to certain preferred embodiments, variations and modifications exist within the scope and spirit of one or more independent aspects of the invention as described. Various features and advantages of the invention are set forth in the following claims.

1. A flexible assembly line comprising:
a common welding station including
a first set of tooling adapted to engage and support a first type of vehicle frame, and
a second set of tooling adapted to engage and support a second type of vehicle frame, a base geometry of which is not common with the first type, wherein the first set of tooling is provided on a first side of a rotatable unit and the second set of tooling is provided on a second side of the rotatable unit such that the rotatable unit is rotatable about a pivot axis to present either the first set of tooling or the second set of tooling for a welding operation;
a first dedicated welding station having dedicated tooling particularly adapted to engage and support only the first type of vehicle frame; and
a second dedicated welding station having dedicated tooling particularly adapted to engage and support only the second type of vehicle frame.

2. The flexible assembly line of claim 1, further comprising at least one welding robot positioned adjacent both the first and second dedicated welding stations and operable to perform primary attachment welding on either the first or second types of vehicle frames or both the first and second types of vehicle frames.

3. The flexible assembly line of claim 2, further comprising at least one welding robot positioned at the common welding station and operable to perform supplemental welding on either the first or second types of vehicle frames or both the first and second types of vehicle frames.

4. The flexible assembly line of claim 1, further comprising a servo motor coupled to the rotatable unit and operable to drive the rotatable unit about the pivot axis.

5. The flexible assembly line of claim 1, wherein the rotatable unit has a 360-degree range of motion about the pivot axis.

6. The flexible assembly line of claim 1, further comprising a transfer device positioned between the common welding station and both of the first and second dedicated welding stations and operable to transport a vehicle frame of either the first or second type between either one of the first and second dedicated welding stations and the common welding station.

7. The flexible assembly line of claim 1, further comprising a track upon which both the first and second dedicated welding stations are movably supported transversely to an assembly direction of the assembly line.

8. The flexible assembly line of claim 1, further comprising a second common welding station including a third set of tooling adapted to engage and support the first type of vehicle frame and a fourth set of tooling adapted to engage and support the second type of vehicle frame, wherein the third set of tooling is provided on a first side of a rotatable unit of the second common welding station and the fourth set of tooling is provided on a second side of the rotatable unit of the second common welding station such that the rotatable unit of the second common welding station is rotatable about a pivot axis to present either the third set of tooling or the fourth set of tooling for a welding operation.

9. A flexible assembly line comprising:
a common welding station including
a fixed base,
a table rotatably coupled to the fixed base about a rotational axis, the table having a first side and an opposing second side,
a first set of tooling coupled to the first side of the table, the first set of tooling configured to engage and support a first vehicle frame, and
a second set of tooling coupled to the second side of the table, the second set of tooling configured to engage and support a second vehicle frame, the second vehicle frame being geometrically different than the first vehicle frame;
wherein the table is moveable about the rotational axis to present either the first side of the table or the second side of the table for a welding operation.

10. The flexible assembly line of claim 9, wherein the first set of tooling includes first base elements each selectively coupled to the first side of the table, and wherein the second set of tooling includes second base elements each selectively coupled to the second side of the table.

11. The flexible assembly line of claim 10, wherein the first set of tooling includes first releasable holding mechanisms moveably coupled to the first base elements between an open position and a closed position, and wherein the second set of tooling includes second releasable holding mechanisms moveably coupled to the second base elements between an open position and a closed position.

12. The flexible assembly line of claim 10, wherein the table includes a plurality of arms extending away from the rotational axis, and wherein one of the first base elements and one of the second base elements are coupled to one arm of the table.

13. The flexible assembly line of claim 12, wherein the one of the first base elements and the one of the second base elements are selectively coupled to the one arm in at least two positions.

14. The flexible assembly line of claim 9, wherein the first set of tooling includes first base elements fixed to a receiving element, and wherein the receiving element is selectively coupled to the first side of the table.

15. The flexible assembly line of claim 9, further comprising a servo motor coupled between the fixed base and the table, wherein the servo motor is operable to rotate the table about the rotational axis relative to the fixed base.

16. The flexible assembly line of claim 15, wherein the table has a 360-degree range of motion about the rotational axis.

17. The flexible assembly line of claim 9, further comprising a first dedicated welding station having dedicated tooling particularly adapted to engage and support only the first vehicle frame and a second dedicated welding station having dedicated tooling particularly adapted to engage and support only the second vehicle frame.

18. The flexible assembly line of claim 17, further comprising a transfer device positioned between the common welding station and both of the first and second dedicated welding stations and operable to transport the first and second vehicle frames between the first and second dedicated welding stations and the common welding station.

19. A method of constructing vehicle frames on a flexible assembly line, the method comprising:
joining separate elements of a first vehicle frame of a first type by welding at a first dedicated welding station;
joining separate elements of a second vehicle frame of a second type, a base geometry of which is not common to the first type, by welding at a second dedicated welding station;
providing a common welding station comprising:
a first configuration in which a first set of tooling is adapted for engaging and supporting the first vehicle frame, and
a second configuration in which a second set of tooling is adapted for engaging and supporting the second vehicle frame;
transferring the joined elements of the first vehicle frame to the common welding station such that the first vehicle frame is engaged and supported by the first set of tooling;
further bonding the joined elements of the first vehicle frame by welding at the common welding station;
rotating the common welding station into the second configuration;
transferring the joined elements of the second vehicle frame to the common welding station such that the second vehicle frame is engaged and supported by the second set of tooling; and
further bonding the joined elements of the second vehicle frame by welding at the common welding station.

20. The method of claim 19, wherein the common welding station is a first common welding station, wherein the method further comprising transferring the first vehicle frame from the first common welding station to a second common welding station before the second vehicle frame is transferred to the first common welding station.
